(19) United States
(12) Patent Application Publication
(10) Pub. No.: US 2009/0201376 A1
(43) Pub. Date: Aug. 13, 2009

(54) Apparatus for Calibrating an Optical Camera and/or an Infrared Camera

(75) Inventors: Guenter Bauer, Petershausen (DE); Antje Neve, Poing (DE); Stephan Thoma, Muenchen (DE)

Correspondence Address: CROWELL & MORING LLP;INTELLECTUAL PROPERTY GROUP, P.O. BOX 14300, WASHINGTON, DC, 20044-4300, US

(73) Assignee: Bayerische Motoren Werke Aktiengesellschaft, Muenchen (DE)

(21) Appl. No.: 12/371,309

(22) Filed: Feb. 13, 2009

Related U.S. Application Data
(63) Continuation of application No. PCT/EP2007/006836, filed on Aug. 2, 2007.

(30) Foreign Application Priority Data
Aug. 17, 2006 (DE) 10 2006 038.423.7

(51) Int. Cl. H04N 17/00

(52) U.S. Cl. 348/187; 348/E17.001

(57) ABSTRACT

An apparatus is provided for calibrating an optical camera and/or an infrared camera, in particular an infrared tele-camera, that is/are arranged in a motor vehicle and that has a checkered appearance with first and second fields. In order to make the known apparatus suitable for a plurality of camera systems, it is suggested that the first fields are heated or cooled.

### CROSS REFERENCE TO RELATED APPLICATIONS

This application is a continuation of PCT International Application No. PCT/EP2007/0006836, filed Aug. 2, 2007, which claims priority under 35 U.S.C. § 119 to German Patent Application No. 10 2006 038 423.7, filed Aug. 17, 2006, the entire disclosures of which are herein expressly incorporated by reference.

### BACKGROUND AND SUMMARY OF THE INVENTION

The invention relates in particular to an apparatus for calibrating an optical camera and/or an infrared camera, in particular an infrared tele-camera, that is/are arranged in a motor vehicle and that has a checkered appearance with first and second fields.

An exact knowledge of the camera parameters such as, e.g., the focus, is required for most methods of image processing. However, the parameters indicated by the manufacturer are meaningful only to a limited extent when the particular camera is part of an image processing system. Thus, e.g., frame grabbers connected in between camera and processing computer can falsify these parameters.

It is therefore important to subject the completely constructed image processing system to a calibration. Processes are used for this that calculate the parameters of the particular camera system based on known objects in the image. In a known process a checkered pattern is used as known object (vgl. http://www.vision.caltech.edu/bougueti/calib doc/).

The intersecting points of the individual edges are precisely determined by subpixels in the image, which makes possible an association between real three-dimensional points and two-dimensional points in the image.

The present invention solves the problem of making available a calibrating apparatus suitable for a plurality of camera systems.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 illustrates an exemplary embodiment of an apparatus for calibrating an optical camera or an infrared camera, in accordance with the present invention.

FIG. 2 illustrates a side view of an exemplary embodiment of an apparatus for calibrating an optical camera or an infrared camera, in accordance with the present invention.

### DETAILED DESCRIPTION OF THE DRAWINGS

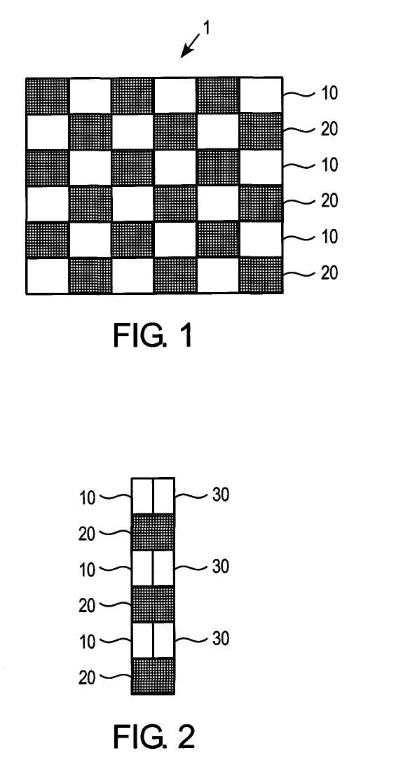

An apparatus for calibrating an optical camera or an infrared camera is illustrated in FIG. 1. The apparatus has a checkered appearance and includes a plurality of first and second fields 10, 20 that are heated or cooled. As illustrated in FIG. 2, a side view of the apparatus 1 shows an embodiment in which Peltier elements 30 are positioned behind the first fields 10.

An aspect of the invention is to load the optically differently-colored fields of the known checkered calibrating apparatus with a different temperature. The first fields are heated or cooled, in distinction to the second fields, so that the first fields have another temperature than the second fields. If an apparatus in accordance with the invention is in front of a vehicle in which an optical as well as an infrared camera, in particular an infrared tele-camera, are provided the apparatus generates a contrast-rich checkered image in the optical camera as well as in the infrared camera, in particular in an infrared tele-camera.

In an exemplary embodiment of the invention a Peltier element is provided behind each of the first fields, preferably the white fields. In a particular development of this embodiment the Peltier elements are arranged behind each of the first fields in such a manner that the first fields are cooled.

An exemplary embodiment of the invention provides that the Peltier elements are arranged behind each of the first fields in such a manner that the second fields are heated by the Peltier elements.

An exemplary embodiment of the invention provides that the total thickness formed by a first field and the Peltier element located behind it corresponds substantially to the thickness of the second field. A further development of this embodiment of the invention provides that the first fields and the second fields are formed by quadratic metal plates, that the cooling side of the Peltier element is in thermal contact with one of the first fields, that the heating side of the Peltier element is in thermal contact with a carrying metal plate and that the first fields are fastened indirectly via the Peltier element and the second fields are fastened directly on the carrying metal plate.

Such a checkered apparatus has a level surface, and in which a Peltier element cools a first field and each of the second fields is heated via the carrying metal plate heated by all Peltier elements. The first fields are preferably quadratic white fields and the second fields are quadratic black fields. The first and the fields as well as the carrying metal plate may be made of aluminum.

Quite sharp tighten transitions between the first and the second fields can be very simply adjusted by the use of Peltier elements. Likewise, the temperature difference between the white fields and the black fields can be adjusted at a very variable level via the electric current flowing through the Peltier elements. It is understood that instead of the white fields even the black fields can be cooled and that the white fields can be heated by the Peltier elements. In addition, even such temperature distributions that deviate from a checkered distribution of heat can be adjusted in a very variable manner by an appropriate control of the Peltier elements if this is purposeful in the framework of the calibration.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An apparatus for calibrating at least one of an optical camera and an infrared tele-camera, that is arranged in a motor vehicle and that has a checkered appearance with a plurality of first and second fields, wherein the first fields are heated or cooled.

2. The apparatus according to claim 1, wherein a Peltier element is provided behind each of the first fields.

3. The apparatus according to claim 2, wherein the Peltier elements are arranged behind each of the first fields such that the first fields are cooled.

4. The apparatus according to claim 2, wherein the Peltier elements are arranged behind each of the first fields such that the second fields are heated by the Peltier elements.

5. The apparatus according to claim 1, wherein a total thickness formed by one of the first fields and the Peltier element located behind the one first field corresponds substantially to the thickness of the second field.

6. The apparatus according to claim 1, wherein the first fields and the second fields are formed by quadratic metal plates, that a cooling side of the Peltier element is in thermal contact with one of the first fields, a heating side of the Peltier element is in thermal contact with a carrying metal plate and the first fields are fastened indirectly via the Peltier element and the second fields are fastened directly on the carrying metal plate.

7. The apparatus according to claim 3, wherein the Peltier elements are arranged behind each of the first fields such that the second fields are heated by the Peltier elements.

8. The apparatus according to claim 2, wherein a total thickness formed by one of the first fields and the Peltier element located behind the one first field corresponds substantially to the thickness of the second field.

9. The apparatus according to claim 3, wherein a total thickness formed by one of the first fields and the Peltier element located behind the one first field corresponds substantially to the thickness of the second field.

10. The apparatus according to claim 4, wherein a total thickness formed by one of the first fields and the Peltier element located behind the one first field corresponds substantially to the thickness of the second field.

11. The apparatus according to claim 2, wherein the first fields and the second fields are formed by quadratic metal plates, that a cooling side of the Peltier element is in thermal contact with one of the first fields, a heating side of the Peltier element is in thermal contact with a carrying metal plate and the first fields are fastened indirectly via the Peltier element and the second fields are fastened directly on the carrying metal plate.

12. The apparatus according to claim 3, wherein the first fields and the second fields are formed by quadratic metal plates, that a cooling side of the Peltier element is in thermal contact with one of the first fields, a heating side of the Peltier element is in thermal contact with a carrying metal plate and the first fields are fastened indirectly via the Peltier element and the second fields are fastened directly on the carrying metal plate.

13. The apparatus according to claim 4, wherein the first fields and the second fields are formed by quadratic metal plates, that a cooling side of the Peltier element is in thermal contact with one of the first fields, a heating side of the Peltier element is in thermal contact with a carrying metal plate and the first fields are fastened indirectly via the Peltier element and the second fields are fastened directly on the carrying metal plate.

14. The apparatus according to claim 5, wherein the first fields and the second fields are formed by quadratic metal plates, that a cooling side of the Peltier element is in thermal contact with one of the first fields, a heating side of the Peltier element is in thermal contact with a carrying metal plate and the first fields are fastened indirectly via the Peltier element and the second fields are fastened directly on the carrying metal plate.

15. A system for calibrating at least one of an optical camera and an infrared tele-camera, that is arranged in a motor vehicle, with software for the calibration, comprising:
an apparatus that is arranged in a motor vehicle and that has a checkered appearance with a plurality of first and second fields, wherein the first fields are heated or cooled.

16. The system according to claim 14, wherein a Peltier element is provided behind each of the first fields.

17. The system according to claim 15, wherein the Peltier elements are arranged behind each of the first fields such that the first fields are cooled.

18. The system according to claim 15, wherein the Peltier elements are arranged behind each of the first fields such that the second fields are heated by the Peltier elements.

19. The system according to claim 14, wherein a total thickness formed by one of the first fields and the Peltier element located behind the one first field corresponds substantially to the thickness of the second field.

20. The system according to claim 14, wherein the first fields and the second fields are formed by quadratic metal plates, that a cooling side of the Peltier element is in thermal contact with one of the first fields, a heating side of the Peltier element is in thermal contact with a carrying metal plate and the first fields are fastened indirectly via the Peltier element and the second fields are fastened directly on the carrying metal plate.
